(19) United States
(12) Patent Application Publication
(10) Pub. No.: US 2018/0309724 A1
(43) Pub. Date: Oct. 25, 2018

(54) CONTROL PLANE NETWORK SECURITY

(71) Applicant: RADIFLOW LTD., Tel Aviv (IL)

(72) Inventors: Yehonatan Kfir, Givaat Shmuel (IL); Ilan Barda, Raanana (IL)

(21) Appl. No.: 15/885,875

(22) Filed: Feb. 1, 2018

Related U.S. Application Data
(60) Provisional application No. 62/488,882, filed on Apr. 24, 2017.

(51) Int. Cl. H04L 29/06

(52) U.S. Cl. CPC H04L 63/0245; H04L 63/1408; H04L 63/0263

(57) ABSTRACT

A method for monitoring or controlling one or more packets propagating through a plant communication network of an industrial control system (ICS) comprising sensors, end devices, and programmable logic controllers (PLCs), the method comprising: receiving at least one packet traversing the plant communication network; detecting a control plane (CP) action associated with the at least one packet, responsive to one or more features of the at least one packet; determining at least one firewall rule responsive to the at least one packet and the detected CP action; and performing a firewall action on a packet comprised in the at least one packet responsive to the determined firewall rule, the firewall action comprising one or more of: allowing the packet, blocking the packet, requesting user authentication, and logging the packet.

### RELATED APPLICATIONS

The present application claims the benefit under 35 U.S.C. § 119(e) of U.S. provisional application No. 62/488,882 filed Apr. 24, 2017, the content and disclosure of which are incorporated herein by reference in their entirety.

### TECHNICAL FIELD

Embodiments of the disclosure relate to an apparatus and related methods for providing network security.

### BACKGROUND

A modern industrial plant is typically a complicated environment comprising an integrated system of automated production equipment, monitoring systems, and computers that control the equipment responsive to data provided by the monitoring systems and human instruction. By way of example, the plant may comprise: production equipment, such as production robots, and chemical reactors; component delivery systems, such as conveyor belts, and pick and place machines; and monitoring systems, such as visual inspection systems and water quality monitors. The various plant components are controlled and monitored in real time to cooperate and automatically perform a production job to which the plant is assigned by control signals transmitted over a plant communication network. Operational Technology (OT) refers to computing systems that are used to monitor events and processes of components in an industrial plant and to manage and control the operation of said plant components. OT typically used in contradistinction to Information Technology (IT) that refers to computing systems used for data-centric computing for enterprises.

Communication devices and computational resources comprised in an OT system that transmit and receive the control signals through a plant communication network are collectively referred to as an industrial control system (“ICS”). The control signals are typically in the form of a data packet configured in accordance with an industrial protocol (“Indprot”). A data packet typically includes a header that carries certain types of metadata and routing information in addition to a payload. For convenience of presentation, data packets used in an ICS for control and monitoring of industrial plant components in accordance with a given Indprot may be referred to herein as “Indprot packets”, or simply “packets”.

Supervisory Control and Data Acquisition (SCADA) refers to a monitoring System for the ICS, which allows human operators, to remotely supervise the ICS by analyzing acquired data upon which they can decide to send commands or trigger alerts. SCADA systems comprise programmable logic controllers (PLCs), which are computational devices that execute predetermined logic based on the inputs from readings of sensors in order to control outputs by end devices of the plant. These processes typically happen autonomously without requiring input from the operator. PLCs are sometimes called Process Automation Controllers (PACs). The logic controlling the PLC actions, which may be referred to as “controller logic”, may be changed (“written”) by a user via an Engineering Station (“ES”).

ICS activities can be separated into data-plane activities and control-plane activities. The data-plane, sometimes referred to as the user plane, is used by SCADA applications to communicate process parameters and physical measurements between plant components and a human operator via a Human Machine Interface (HMI) on an Operator Station. Control plane (“CP”) actions include engineering activity, optionally conducted through an ES, that are related to maintaining PLCs. CP actions are typically but not necessarily through a user interacting with an ES. As such, CP actions may alternatively be referred to herein as “user-initiated control plane processes”. However, CP actions can be initiated by automated machine, without a user initiating them. Examples of CP actions include reading or writing (changing) of: PLC firmware, PLC logic, PLC configuration settings, or state of PLCs. Typically, PLCs are restricted to be connected only ES and not Operator Stations in order to minimize access to them from office computers and the internet for instance. The data-plane and control-plane typically use different indprot protocols. Indprots used for data-plane activities include open and standardized protocols such as MODBUS, PROFINET, DNP3 and others. Unlike data plane indprots, control plane indprots may be vendor specific proprietary protocols.

Modern ICS's typically have open architectures and standard technologies highly interconnected with other corporate IT networks and the Internet, and are mostly based on standard embedded systems platforms, applied in various devices, such as routers or cable modems. They also often make use of, at least in part, commercial off-the shelf software, such as, Ethernet, TCP/IP, HTTP and Windows. This standardization has resulted in reduction of costs, improved ease of use, and enabled the remote control and monitoring from various locations. However, an important drawback derived from the connection to intranets and communication networks is the increased vulnerability to computer network-based attacks.

Malfunctioning of, and/or down time, in a modern automated industrial plant is generally extremely expensive and can carry substantial liability. Manufacturing components and processes in the plant are interdependent, and typically must operate in synchrony. Malware damage to a component of an automated industrial plant can therefore be amplified well beyond any particular damage to the component, and well beyond what might be sustained by an enterprise communication and data system or home computer data system damaged by the same malware.

### SUMMARY

Industrial plants may implement configurations of firewalls which monitor and control passage of incoming and outgoing data packets based on predetermined security rules. By way of example, a firewall may: allow a data packet to pass, in which the firewall's output comprises the packet; or block the data packet, in which the output comprises a null output indicating the packet being dropped. The firewall may also log an allowed packet, such that the firewall's output for the allowed packet also includes a log message.

An aspect of an embodiment of the disclosure relates to a method for monitoring and controlling passage of data packets traversing an ICS network, responsive to the packet's association with at least one event or action in a control plane (CP) of the ICS network. A method in accordance with an embodiment of the disclosure may be referred to herein as an “Industrial end point protection” (IEPP) method. A firewall that monitors and controls passage of packets in accordance with an embodiment of the disclosure may be referred to as an IEPP Firewall.

An IEPP method in accordance with an embodiment of the disclosure, for monitoring and controlling one or more packets propagating through an ICS network, comprises: receiving at least one packet; detecting a CP action associated with the at least one packet, responsive to one or more features of the at least one packet; determining at least one firewall rule responsive to the at least one packet and the detected CP action; and performing a firewall action on the packet responsive to the determined firewall rule.

Examples of a CP action include: login, logout, starting CPU, stopping CPU, scanning PLCs, writing PLC logic, reading PLC logic, reading configuration values, and writing configuration values.

In an embodiment of the disclosure, the CP action is identified in accordance with a user action database (UADB) comprising association rules for associating a packet characterized with one or more packet features with a CP action.

In an embodiment of the disclosure, the UADB comprises empirically-derived association rules gathered through initiating CP processes, optionally at an Engineering Station, gathering packets that are triggered by the initiation of a given CP action, and processing the gathered packets to identify packet features that are consistently associated with initiation or occurrence of the given CP action.

A firewall rule in accordance with an embodiment of the disclosure is identified in accordance with a firewall rule database (FRDB) comprising association rules for associating a packet with a firewall rule. Optionally, the packet was previously associated with a CP action. Due to a firewall rule, as a result in such a case, being associated with a CP action, a firewall rule may alternatively be referred to herein as a “CP event”.

In an embodiment of the disclosure, the firewall action is chosen in accordance with a firewall action database (FADB) that comprises association rules for associating one or more firewall rules with one or more firewall actions selected from: allow the packet, request user authentication, block the packet, or log the packet.

In an embodiment of the disclosure, the FADB comprises association rules for associating a sequence of firewall rules with one or more firewall actions. As such, in accordance with an embodiment of the disclosure, an IEPP Firewall is operable to perform a given firewall action responsive to a given sequence of received packets. Optionally, at least one packet of the sequence of packets is associated with a CP action.

In an embodiment of the disclosure, a firewall may be operable to automatically modify an association rule controlling its function responsive to detection of a predetermined field value or a set of field values in a packet. In a more particular embodiment, the IEPP method may comprise reconfiguring one or more association rules in the FADB responsive to detection of a given CP action.

In an embodiment of the disclosure, an association rule, by way of example for associating a packet characterized with one or more packet features with a CP action, a packet with a firewall rule, or one or more firewall rules with one or more firewall actions, as described herein, comprises a lookup table or a classifier such as a decision tree.

In an embodiment of the disclosure, operation of a firewall may be controlled and/or modified through a data-plane HMI. In a more particular embodiment of the disclosure, association rules for controlling operation of an IEPP Firewall, comprised optionally in one or more of a UADB, FRDB and FADB are controllable and modifiable through a data-plane HMI.

In the discussion, unless otherwise stated, adjectives such as “substantially”, “relatively” and “about” modifying a condition or relationship characteristic of a feature or features of an embodiment of the disclosure, are understood to mean that the condition or characteristic is defined to within tolerances that are acceptable for operation of the embodiment for an application for which it is intended. Unless otherwise indicated, the word “or” in the specification and claims is considered to be the inclusive “or” rather than the exclusive or, and indicates at least one of, or any combination of items it conjoins.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the disclosure are described below with reference to figures attached hereto that are listed following this paragraph. Identical structures, elements or parts that appear in more than one figure are generally labeled with a same numeral in all the figures in which they appear. Dimensions of components and features shown in the figures are chosen for convenience and clarity of presentation and are not necessarily shown to scale.

FIG. 1 schematically illustrates, as a block diagram, an IEPP Firewall in accordance with an embodiment of the disclosure;

FIG. 2 is a flowchart showing an IEPP process in accordance with an embodiment of the disclosure, performed by an IEPP Firewall as shown in FIG. 1;

FIG. 3 is a flowchart showing a firewall rule sequence analysis method in accordance with an embodiment of the disclosure.

### DETAILED DESCRIPTION

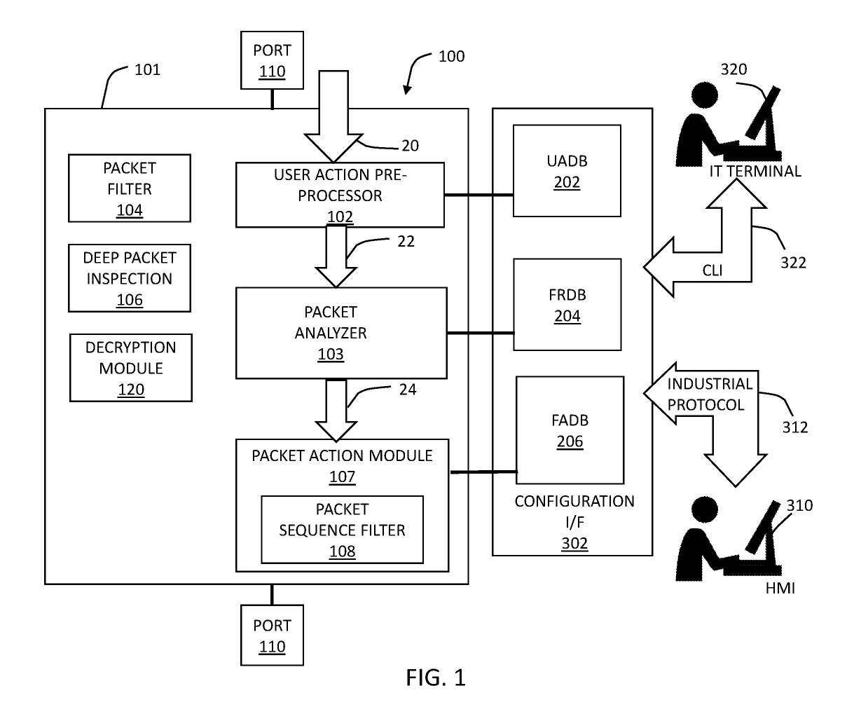

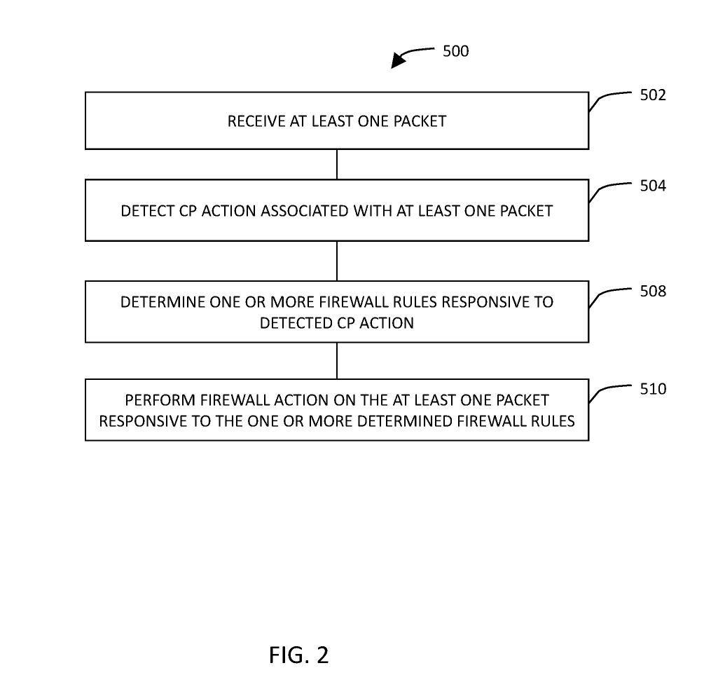

Reference is made to FIG. 1 that schematically illustrates, as a block diagram, an IEPP Firewall 100 in accordance with an embodiment of the disclosure. The components and functions of IEPP Firewall 100 will be described herein in conjunction with the IEPP Firewall's performance of an IEPP process 500 in accordance with an embodiment of the disclosure, a flowchart for which is shown in FIG. 2.

IEPP Firewall 100 is operable to be connected to a plant communication network serving an ICS (not shown) via one or more communication ports 110, and comprises a plurality of processing modules that analyze and process packets received by or traversing the IEPP Firewall. Optionally, the processing modules are comprised in a processor 101 operable to process the received packet, for example performing IEPP process 500 in accordance with an embodiment of the disclosure, responsive to a set of computer executable instructions stored in a memory comprised in or operatively connected to IEPP Firewall 100. Processor 101 is optionally a physical processor, a plurality of processors, or one or more virtual processors. In an embodiment of the disclosure, processor 101 comprises a plurality of computing modules, which may include one or more of the following processing modules as described hereinbelow: a User Action Pre-Processor (UAPP) 102, a Packet Analyzer (PA) 103, a PActionM 107, and a Packet Sequence Filter (PSF) 108. Optionally, processor 101 comprises a packet filter (PF) 104; a Deep Packet Inspection (DPI) Engine 106; and a decryption module 120.

Whereas in FIG. 1, IEPP Firewall 100 is schematically shown as separate components that appear to be hardware components, an IEPP Firewall in accordance with an embodiment of the disclosure may be a “virtualized firewall” defined by a software component, optionally comprised in a memory of a computer device that is operatively connected to a node of an ICS. Alternatively or additionally, an IEPP Firewall is integrated to the hardware of an ICS node, optionally as a hardware component, a software component comprised in a memory, or a combination thereof.

In an embodiment of the disclosure, IEPP process 500 comprises in a block 502 receiving a packet. As schematically shown by way of example in FIG. 1, an Indprot packet 20 is received by IEPP Firewall 100 into processor 101.

In an embodiment of the disclosure, IEPP process 500 comprises Block 504, which comprises detecting CP action associated with a received packet. Examples of CP actions include: Login, Logout, starting CPU, stopping CPU, scanning PLCs, writing PLC logic, reading PLC logic, reading configuration values, and writing configuration values.

Optionally, Block 504 is carried out by UAPP 102, which is operable to detect a CP action associated with Indprot packet 20 responsive to one or more features of the packet. Optionally, this detection is made in accordance with a user action database (UADB) 202, which comprises association rules, by way of example lookup tables or classifiers such as decision trees, for associating a packet characterized with one or more packet features with a CP action.

Optionally, the one or more packet feature comprises presence of a given field in the packet, and/or a value of said given field. Packets received by processor 101 are optionally processed by one or more packet parsers to identify fields and/or field values, optionally in a header or a payload of the packet. Optionally, the one or more packet features comprise a feature of a packet that is identifiable without parsing the packet. Optionally, a non-parsed packet feature is a protocol (by way of example an internet protocol such as HTTP or FTP) under which the packet is transmitted, a value of a given byte comprised in the packet, or a size of a payload.

In certain cases, packets traversing an ICS are encrypted to provide security. However, such encryption may interfere with packet analysis by IEPP Firewall 100. As such, processor 101 optionally comprises a decryption module 120, by way of example comprising a private key, operable to decrypt incoming packets.

Optionally, features of Indprot packet 20 are extracted in processor 101 by PF 104 and/or PDI 106. Optionally, PF 104, is operable to extract values from fields in the packet header. The packet header fields may comprise one or more of the fields included in packet 2, by way of example, IP source, IP destination, subnet source, subnet destination, port source, port destination, transport protocol, and MAC address. The fields may also comprise the user action ID field added by UAPP 102. Optionally, DPI Engine 106 is operable to extract values from fields of the packet payload. Payload fields may be different depending on the industrial protocol. Examples include the following: Industrial protocol MODBUS includes payload fields unit ID, function code, and address; Industrial protocol S7 includes a payload field PDU; and Industrial protocol DNP3 includes payload fields source/destination and group.

In an embodiment of the disclosure, UAPP 102 is operable to generate an output packet (“UAPP output packet”) 22, which comprises the fields comprised in packet 20, as well a as a new field, a “user action ID” field, which indicates the CP action identified by UAPP 102 in accordance with UADB 202. Where UAPP 102 fails to identify a CP action for packet 20, the user action ID field of UAPP output packet 22 is not appended or is appended and has a null value.

In an embodiment of the disclosure, the association rules comprised in UADB 202 are previously derived through empirical experimentation of the ICS, gathered by initiating CP actions, optionally at an ES of the ICS. By way of example, packets that are triggered by the initiation of a given CP action are processed to identify packet features that are consistently associated with the initiation of the given CP process. This process is repeated for a plurality of CP processes, and the results are used to build the association rules comprised in UADB 202. The empirically-derived associations between the gathered packets and a set of CP actions may be derived using machine learning. Optionally, an association rule comprised in the UADB may be a classifier selected from: a decision tree, a Support Vector Machine (SVM), a Random Forest classifier and a Nearest Neighbor classifier. Optionally, the decision tree is a classification and regression tree (CART).

In an embodiment of the disclosure, IEPP process 500 comprises Block 508, which comprises determining a firewall rule responsive to Indprot packet 20. Optionally, determining the firewall rule comprises identifying a firewall rule associated with UAPP output packet 22 (and by extension packet 20). In an embodiment of the disclosure, block 508 is carried out by PA 103, which is operable to determine a firewall rule responsive to packet 20. Optionally, the determination is made in accordance with a firewall rule database (FRDB) 204 comprising association rules, by way of example lookup tables or classifiers such as decision trees, for associating a packet with a firewall rule. Optionally, PA 103 is operable to determine a firewall rule associated with the packet, responsive to at least one feature of packet 20, one or more CP actions as associated with the packet in block 504, or a combination thereof. By way of example, FRDB 204 may comprise an association rule that an Indprot packet 20 having an IP destination field value of 2.2.2.2 and detected as being associated with a CP action of “write PLC logic” by UAPP 102 is to be determined as being associated with a firewall rule identified as “firewall rule 1”. By way of another example, FRDB 204 may comprise an association rule that any received Indprot packet detected as being associated with a CP action of “scanning PLCs” by UAPP 102 is to be determined as being associated with a firewall rule identified as “firewall rule 2”.

In an embodiment of the disclosure, PA 103 is operable to append a firewall rule ID field to UAPP output packet 22, to generate a PA output packet 24. As such, if an exemplary UAPP output packet 22 includes an IP destination field having a value of 2.2.2.2 and includes a user action field having the value of “write PLC logic”, the packet is optionally appended with a firewall rule ID field having a value of “1”, to generate PA output packet 24.

In an embodiment of the disclosure, IEPP process 500 comprises Block 510, which comprises performing a firewall action on packet 20 responsive to the firewall rule associated with the packet in block 508. Examples of a firewall action include: allowing the packet, requesting user authentication, blocking the packet, or logging the packet. In an embodiment of the disclosure, the firewall action is determined in accordance with a firewall action database (FADB) 206 that comprises association rules, by way of example lookup tables or classifiers such as decision trees, for associating a packet characterized with a given firewall rule with a given firewall action.

In an embodiment of the disclosure, block 510 is carried out by PActionM 107, which is operable to determine a firewall action for IEPP Firewall 100 to perform, responsive to one or more firewall rules determined by PA 103.

Optionally, PA output packet 24 is received as input by PActionM 107. PActionM 107 determines a firewall action for IEPP Firewall 100 to perform on the packet responsive to the firewall rule ID field comprised in PA output packet 24, in accordance with an association rule comprised in FADB 206. By way of example, FADB 206 comprises an association rule that all PA output packets having a firewall rule ID field value of 1 are blocked. As such, exemplary Indprot packet 22 described above, which includes an IP destination field having a value of 2.2.2.2, detected as being associated with a CP action of “write PLC logic” by UAPP 102, and was designated by PA 103 as being associated with a firewall rule 1, will be blocked by IEPP Firewall 100.

In certain cases, it may be advantageous to determine a firewall action responsive to a sequence of packets received by IEPP Firewall 100 rather than through a single packet, or determine a sequence of firewall actions response to a sequence of packets. In an embodiment of the disclosure, PActionM 107 comprises a packet sequence filter (PSF) 108 that is operable to analyze a sequence of multiple packets over time, and to determine a firewall action or a sequence of firewall actions responsive to the sequence. A process of determining firewall action based on a sequence of packets in accordance with an embodiment of the disclosure is optionally comprised in Block 510, and may be referred to herein as “event sequence analysis”.

When performing event sequence analysis in accordance with an embodiment of the disclosure, PSF 108 is optionally operable to determine a firewall action for PActionM 107 to perform or initiate responsive to not only a firewall rule associated with a presently received PA output packet 24, but firewall rules associated with previously received packets as well.

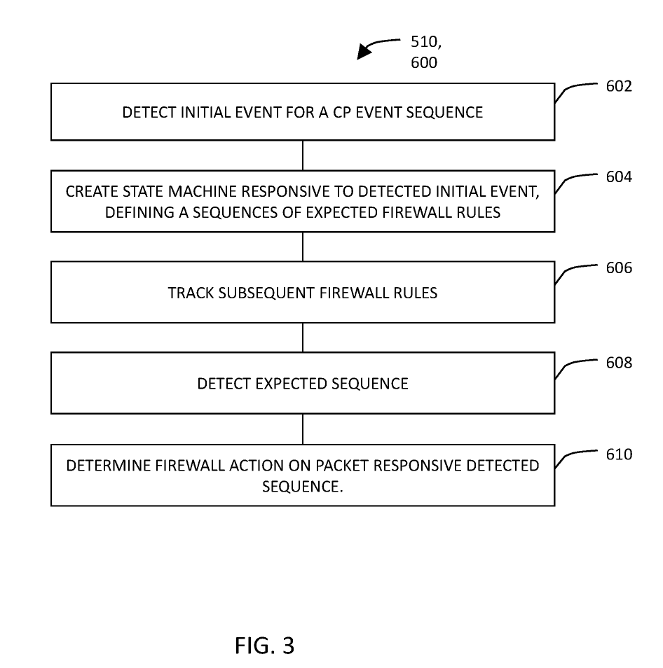

A flow chart depicting a firewall rule sequence analysis method 600 in accordance with an embodiment of the disclosure is shown in FIG. 3. In an embodiment of the disclosure, FADB 206 comprises association rules designating certain firewall rules as an initial event for a firewall rule sequence. Block 602 of method 600 comprises registering a firewall rule, optionally identified in block 508 (as shown in FIG. 2) and identifying the firewall rule as an initial event for a firewall rule sequence. A sequence of firewall rules determined by a PA 103, by way of example responsive to a sequence of Indprot packets received by IEPP Firewall 100, may be referred to herein as a “CP process”.

In an embodiment of the disclosure, event sequence analysis method 600 comprises a Block 604, which comprises defining a sequence of one or more expected firewall rules associated with future packets that may be subsequently registered by IEPP Firewall 100. Optionally, when PSF 108 registered a firewall rule designated as an initial event according to FADB 206, PSF 108 creates a state machine, which may be referred to herein as a packet sequence tracker, which defines a predetermined number of states comprising firewall actions and a predetermined set of inputs comprising firewall rules associated with future packets, that would change a state of the packet sequence tracker. The set of inputs to transition the state of the state machine would comprise a sequence of expected subsequent firewall rules (optionally as defined by an association rule in FADB 206) that would be indicative a particular CP process. As such, FADB 206 is operable to associate a firewall action with a given firewall rule sequence, in accordance with the packet sequence tracker, such that PActionM 107 would perform the associated firewall action upon detection of the given firewall rule sequence.

In an embodiment of the disclosure, event sequence analysis method 600 comprises one or more of: block 606 comprising tracking firewall rules subsequent to the detected initial event; block 608 comprising detecting an expected firewall rule sequence responsive to the tracked firewall rules; and block 610 comprising determining a firewall action responsive to the detected Firewall sequence. By way of example, once a given initial event is detected by PSF 108, subsequent firewall rules are tracked by PSF 108 in order to detect an expected firewall rule associated with the initial event detected in block 602, in accordance with FADB 206. If the tracked firewall rules result in an expected firewall rule sequence, then PSF 108 instructs PActionM 107 to perform a firewall action associated with the expected, and now detected, firewall rule sequence.

In an embodiment of the disclosure, a packet sequence tracker is operable to limit tracking subsequent firewall rules associated with packets sharing a given packet feature. By way of example, upon the PSF registering a given firewall rule as an initial event, the tracking of subsequent firewall rules by a given packet sequence tracker may be limited to firewall rules associated with packets that share the same source and destination of the packet, optionally associated with the initial event.

Optionally, a packet sequence tracker stays active within a defined time widow, such that, upon detection of an initial event, PSF 108 tracks subsequent firewall rules for detection of an expected firewall rule sequence associated with the detected initial event for a pre-defined period of time. As such, a sequence of firewall rules is optionally detected only if the sequence occurs during a pre-defined period of time after the initial event. Alternatively or additionally, a packet sequence tracker is inactivated responsive to a subsequent packet being determined to be associated with a particular firewall rule designated to be a terminating event, in accordance with an association rule comprised in FADB 206.

By way of example, PSF 108 may be configured in accordance with FADB 206 to initiate a packet sequence tracker after receiving a packet associated with firewall rule ID 1, with the inputs including subsequent packets associated with firewall rule ID 2, followed by another packet associated with firewall rule ID 3. Moreover, the FADB association rule requires that the subsequent packets share the same source and destination as the initiating packet, and that the three firewall rules occur within a 10-second time window. As such, a first packet associated with firewall rule ID 1 and a second packet associated with event ID 2 may be allowed, but a third packet associated with firewall rule ID 3 will be blocked, provided that the first, second and third packets share the same source and destination, and the third packet was received within 10 seconds of the first packet. However, a packet associated with firewall rule ID 3 may be allowed to pass in many cases, for example if the packet was not preceded in the previous 10 seconds by earlier packets that were determined to be associated with firewall rule ID 1 and 2 by PA 103. Moreover, registration by IEPP Firewall 100 of a fourth packet associated with a firewall rule ID 4 may serve as an inactivating event for packet sequence tracker.

By way of a more particular example, in an IEPP Firewall 100 protecting an ICS utilizing a given proprietary control-plane industrial protocol may be controlled in the following manner: PA 103 monitors Indprot packets for packet sequences that are associated with a “write PLC logic” CP process, and blocks file transfer packets once a “write PLC logic” CP process is detected. By way of example, write PLC logic CP process may be identified through registration of a sequence of packets, such as exemplary Indprot packets 20-1, 20-2, and 20-3 associated, respectively, with the following three firewall rules: ES scanning for PLCs (firewall rule ID 1); ES connects in MODBUS (firewall rule ID 2); and ES connects to FTP (firewall rule ID 3) by IEPP Firewall 100. Further by way of example, FRDB 204 comprises association rules defining that a packet associated with a CP action of “scanning controller” by UAPP 102 is to be associated with a firewall rule ID 1; a packet having a TCP Destination Port field with a value of “502” is to be associated with a firewall rule 2; and a packet having a TCP Destination Port field with a value of “21” is to be associated with a firewall rule ID 3. Further by way of example, PSF 108 determines firewall activity according to FADB 206, which comprises an association rule that a sequence of packets associated, respectively, with firewall rule IDs 1, 2 and 3, which are received by the IEPP Firewall within a 10 second window, characterizes a CP process of “write PLC logic”, for which packets such as packet 20-3 associated with an event of an “ES connecting to an FTP” is to be blocked. As a result, in accordance with the above example, packet 20-3 is blocked. However, in the given example, a packet identical to 20-3 that was not preceded by a sequence of packets 20-1 and 20-2 within a 10 second window, or was preceded by a sequence of packets—20-1 and 20-2 as well as a packet 20-4 associated with firewall rule ID 4 that serves as an inactivating event, would not have been blocked.

In certain cases, it is advantageous to have a detection of a particular firewall rule change how subsequently received packets are monitored and controlled. In an embodiment of the disclosure, a packet sequence tracker is configured change its state output in a defined sequence responsive to a sequence of firewall rules. As such, an IEPP Firewall 100 in accordance with an embodiment of the disclosure is configured to, upon detection of a given firewall rule, trigger a change in how the IEPP Firewall controls subsequently received packets. Optionally, performance of a firewall action responsive to a firewall rule or a sequence of firewall rules (block 510), comprises changing a function of PActionM 107 for controlling subsequently received packets, such that a given packet trigger that would have triggered one firewall action before detection of a given firewall rule, triggers a different firewall action after the detection of a given firewall rule. Optionally, PActionM 107 is operable, optionally as defined in FADB 206, to automatically change one or more association rules stored in FADB 206 responsive to detection of a firewall rule or sequence of firewall rules. The automatic reconfiguration of an association rule stored FADB optionally persists for a predetermined period of time, and/or detection of another firewall rule or sequence of firewall rules overriding the automatic reconfiguration. Optionally, the automatic reconfiguration is limited to packets characterized with a given packet feature, for example a packet destination.

By way of example, PActionM 107 is optionally operable, in accordance with FADB 206, to detect at least the following firewall rule (or firewall rule sequence): write PLC logic and read PLC logic, and that the association rules comprises in FADB 206 is configured so that packets associated with a firewall rule of “write PLC logic” are allowed to pass. In an embodiment of the disclosure, the PActionM is operable, following detection of a “write PLC logic” firewall rule, to automatically reconfigure one or more association rules comprised in FADB 206 so that subsequent packets determined to be associated with a “write PLC logic” firewall rule are blocked by the PActionM, thus preventing further changes being made to the PLC logic. The above-described changing of PActionM 107 function to block of subsequent packets associated with a “write PLC logic” firewall rule may be referred to herein as a “lock PLC write” process.

A lock PLC write process in accordance with an embodiment of the disclosure provides certain advantages, such as reducing or preventing unauthorized changes for PLC logic being entered. An example of the lock PCL write process is further illustrated herein below.

Typically, a user wishing to introduce changes to PLC logic may enter the following CP actions:

1) User Authentication/Unlock PLC (allows the logic of the PLC to be modified by an authorized user via the ES);
2) Write PLC logic (introduces user's changes to the PLC logic);
3) Read PLC logic (verifies the just-introduced user changes); and
4) Lock PLC (prevents any changes to the logic of the PLC).

The above sequences of CP actions has a security weakness, in that an unauthorized user that gains access to an ES may introduce malicious changes after CP action 1 (Unlock) and before CP action 4 (Lock). Moreover, if the malicious changes are introduced after CP action 3 (Read PLC logic) during which the changes made to the PLC logic are verified by the authorized user, the malicious, unauthorized changes to the PLC logic would be left undetected (at least until the malicious changes start to cause portions of ICS and/or the plant to malfunction).

In an embodiment of the disclosure, PActionM 107 may be operable to maintain a packet sequence tracker for performing the lock PLC write process that, responsive to detecting a CP action of “write PLC logic”, changes its state to block subsequent packets associated with a CP action of “write PLC logic” resulting in the following sequence of CP actions and resulting state changes:

In an embodiment of the disclosure, PSF 108 is operable to execute the lock PLC write process in accordance with association rules comprised in FADB 206, such that registration of a sequence of packets and associated firewall rules corresponding to the Unlock PLC and Write PCL logic CP actions results in IEPP Firewall 100 activating a packet sequence tracker that allows a first set of packets corresponding to the Write PLC logic CP process, but not subsequent ones, so that further writing of the PLC logic is prevented. This packet sequence tracker is optionally inactivated after a predetermined time delay, and/or after detecting of a subsequent inactiving event, such as a Lock PLC logic CP action. An exemplary sequence of CP action inputs and a sequence of state changes responsive to the inputs of a packet sequence tracker are provided herein below in Table 1:

TABLE 1

| CP Action input | State |
|---|---|
| 0. Default | State 0 (Default): Block packets associated |
| | with CP actions “read PLC logic” or |
| | “write PLC logic” |
| 1. User Authentication/Unlock | Begin packet sequence tracker at state 1: |
| PLC | Allow packets associated with CP actions |
| | “read PLC logic” or “write |
| | PCL logic” |
| 2. Write PLC logic (introduce | State 2: Block subsequent packets |
| user's changes to the PLC | associated with CP action |
| logic) | “write PLC logic” |
| 3. Read PLC logic (for user to | No change in state |
| verify the just-introduced | |
| logic changes) | |
| 4. Lock PLC | End packet sequence tracker and return to |
| | default state 0: Block packets associated |
| | with CP actions “read PLC logic” or |
| | “write PCL logic” |

With the write PLC lock process in place, an unauthorized user would be prevented from entering malicious changes after the authorized user's changes, and even if an unauthorized user nevertheless managed to introduce malicious changes, the malicious changes would be detected through the CP action “Read PLC logic”. The procedure of allowing a CP action of “write PCL logic”, then automatically blocking subsequent “write PLC logic” CP actions, followed by the “read PLC logic” CP action to verify the PLC logic changes after the automatic block has been initiated, may be referred to herein as a “Write-Lock-Verity” method.

Typically, firewalls installed in ICS's have been controlled through enterprise information technology (IT) terminals. A data-plane HMI typically does not have access to managing or modifying ICS firewall configurations.

Reference is now made to FIG. 1. UADB 202, FRDB 204 and FADB 206 in accordance with an embodiment of the disclosure are shown as being comprised in a configuration interface (I/F) 302, which may comprised in or be operatively connected to IEPP Firewall 100. Configuration I/F 302 is operable to provide access for users to control or modify IEPP Firewall 100 operation by modifying association rules comprised in one or more of UADB 202, FRDB 204 and FADB 206 (collectively referred as the association rules databases).

In an embodiment of the disclosure, IEPP Firewall 100 is modeled as a PLC accessed via a SCADA system, such that the function of the IEPP Firewall is operable to be controlled and modified through an HMI 310 in the data plane via an industrial protocol such as MODBUS, schematically represented with a double ended open arrow 312. Optionally, association rules comprised in one or more of the association rules databases are controllable and modifiable through an HMI in data plane via industrial protocol 312. Optionally, functions and engines comprised in IEPP Firewall 100 may be built as virtual function blocks (VFBs), such that various aspects of IEPP Firewall operation may be controllable through the HMI. By way of example, a state of an IEPP Firewall may be changed between locked and unlocked through the HMI.

Typically, day-to-day interaction of a user of a SCADA system is conducted in the data plane, through an HMI at an operator station, while user action in the control plane, for example through an ES, is relatively infrequent. Having a IEPP Firewall 100 that is modeled as a PCL and accessible through an HMI has an advantageous property of allowing a user to monitor for malicious activity occurring in the control plane while interacting with the SCADA system in the data plane.

Firewalls in general, without being limited to IEPP Firewall 100 discussed above, may be modeled as a PLC comprising VFBs such that its function may be controlled via an ES using an industrial protocol. Advantageously, modeling a firewall as a PLC controller and allowing access to configuration of I/F 302 via an ES using an industrial protocol provides OT engineers access to controlling ICS firewall function, which is a task traditionally restricted to IT administrators.

Optionally, IEPP Firewall 100 function is also controllable and modifiable through IT terminal 320 via command line interface (CLI) 322.

There is therefore provided in accordance with an embodiment of the disclosure a method for monitoring or controlling one or more packets propagating through a plant communication network of an industrial control system (ICS) comprising sensors, end devices, and programmable logic controllers (PLCs), the method comprising: receiving at least one packet traversing the plant communication network; detecting a control plane (CP) action associated with the at least one packet, responsive to one or more features of the at least one packet; determining at least one firewall rule responsive to the at least one packet and the detected CP action; and performing a firewall action on a packet comprised in the at least one packet responsive to the determined firewall rule, the firewall action comprising one or more of: allowing the packet, blocking the packet, requesting user authentication, and logging the packet.

There is also provided in accordance with an embodiment of the disclosure a module for monitoring or controlling one or more packets propagating through a plant communication network of an industrial control system (ICS) comprising sensors, end devices, and programmable logic controllers (PLCs), the module comprising: a memory having software comprising a set of computer executable instructions; a user action database (UADB) comprising association rules for associating a packet with a CP action; a control place event database (FRDB) comprising association rules for associating a packet with a firewall rule; a firewall action database (FADB) comprising association rules for associating a packet characterized with a given firewall rule with a given firewall action; a communication port via which the module receives packets, the port being configured to be connected to a portion of the plant communication network; and a processor that processes, responsive to the set of instructions, packets received via the port from the portion of plant communication network to: receive at least one packet traversing the plant communication network; detect a control plane (CP) action associated with the at least one packet, responsive to one or more features of the at least one packet, in accordance with the UADB; determine at least one firewall rule responsive to the at least one packet and the detected CP action; in accordance with the FRDB; and initiate a firewall action on a packet comprised in the at least one packet responsive to the determined firewall rule in accordance with the FADB, the firewall action comprising one or more of: allowing the packet, blocking the packet, requesting user authentication, and logging the packet.

In an embodiment of the disclosure, the CP action is an action that is related to maintaining a PLC operatively connected a plant communication network or operating a computer device configured to interact with the PLC. Optionally, the action is selected from the group consisting of: login to the computer system, logout from the computer device, starting CPU of the computer device, stopping CPU of the computer device, scanning the PLC, writing logic of the PLC, reading logic the PLC, reading configuration values of the PLC, and writing configuration values of the PLC.

Optionally, the one or more features of the packet comprises a value of one or more fields in the packet. Optionally, the one or more features of the packet comprises a feature that does not require parsing a header of the packet to identify fields. Optionally, the feature that does not require parsing is selected from: a value of a byte comprised in the packet; and a byte-length of a payload comprised in the packet. Optionally, one or more packet fields from which the one or more field values is extracted is selected responsive to the identified CP action.

In an embodiment of the disclosure, the firewall action on the packet is initiated responsive to a sequence of firewall rules that characterize a sequence of packets. Optionally, at least one CP action is detected responsive at least one packet of the sequence of packets.

In an embodiment of the disclosure, the method further comprises reconfiguring at least one association rule for determining a firewall action responsive to a subsequently received packet responsive to the identified firewall rule, such that a given packet that would have triggered a given firewall action prior to the reconfiguration triggers a different firewall action following the reconfiguration. Optionally, the reconfiguration is reversed after a predetermined period of time. Optionally, the reconfiguration is responsive to the identified firewall rule being associated with writing logic of the PLC, such that while the received packet is allowed, a subsequently received packet identified as being associated with writing logic of the PLC is blocked.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the disclosure in the present application are provided by way of example and are not intended to limit the scope of the disclosure. The described embodiments comprise different features, not all of which are required in all embodiments of the disclosure. Some embodiments utilize only some of the features or possible combinations of the features. Variations of embodiments of the disclosure that are described, and embodiments of the disclosure comprising different combinations of features noted in the described embodiments, will occur to persons of the art. The scope of the invention is limited only by the claims.

1. A method for monitoring or controlling one or more packets propagating through a plant communication network of an industrial control system (ICS) comprising sensors, end devices, and programmable logic controllers (PLCs), the method comprising:
receiving at least one packet traversing the plant communication network;
detecting a control plane (CP) action associated with the at least one packet, responsive to one or more features of the at least one packet;
determining at least one firewall rule responsive to the at least one packet and the detected CP action; and
performing a firewall action on a packet comprised in the at least one packet responsive to the determined firewall rule, the firewall action comprising one or more of: allowing the packet, blocking the packet, requesting user authentication, and logging the packet.

2. The method according to claim 1, wherein the CP action is an action that is related to maintaining a PLC operatively connected a plant communication network or operating a computer device configured to interact with the PLC, the action being selected from the group consisting of: login to the computer system, logout from the computer device, starting CPU of the computer device, stopping CPU of the computer device, scanning the PLC, writing logic of the PLC, reading logic the PLC, reading configuration values of the PLC, and writing configuration values of the PLC.

3. The method according to claim 1, wherein the one or more features of the packet comprises a value of one or more fields in the packet.

4. The method according to claim 1, the one or more features of the packet comprises a feature that does not require parsing a header of the packet to identify fields.

5. The method according to claim 4, wherein the feature that does not require parsing is selected from: a value of a byte comprised in the packet; and a byte-length of a payload comprised in the packet.

6. The method according to claim 1, wherein one or more packet fields from which the one or more field values is extracted is selected responsive to the detected CP action.

7. The method according to claim 1, wherein the firewall action on the packet is initiated responsive to a sequence of firewall rules that characterize a sequence of packets, and at least one CP action is detected responsive at least one packet of the sequence of packets.

8. The method according to claim 1, further comprising reconfiguring at least one association rule for determining a firewall action responsive to a subsequently received packet responsive to the identified firewall rule, such that a given packet that would have triggered a given firewall action prior to the reconfiguration triggers a different firewall action following the reconfiguration.

9. The method according to claim 8, wherein the reconfiguration is reversed after a predetermined period of time.

10. The method according to claim 8, wherein the reconfiguration is responsive to the determined firewall rule being associated with writing logic of the PLC, such that while the received packet is allowed, a subsequently received packet identified as being associated with writing logic of the PLC is blocked.

11. A module for monitoring or controlling one or more packets propagating through a plant communication network of an industrial control system (ICS) comprising sensors, end devices, and programmable logic controllers (PLCs), the module comprising:
a memory having software comprising a set of computer executable instructions;
a user action database (UADB) comprising association rules for associating a packet with a CP action;
a control place event database (FRDB) comprising association rules for associating a packet with a firewall rule;
a firewall action database (FADB) comprising association rules for associating a packet characterized with a given firewall rule with a given firewall action;
a communication port via which the module receives packets, the port being configured to be connected to a portion of the plant communication network; and
a processor that processes, responsive to the set of instructions, packets received via the port from the portion of plant communication network to:
receive at least one packet traversing the plant communication network;
detect a control plane (CP) action associated with the at least one packet, responsive to one or more features of the at least one packet, in accordance with the UADB;
determine at least one firewall rule responsive to the at least one packet and the detected CP action; in accordance with the FRDB; and
initiate a firewall action on a packet comprised in the at least one packet responsive to the determined firewall rule in accordance with the FADB, the firewall action comprising one or more of: allowing the packet, blocking the packet, requesting user authentication, and logging the packet.

12. The module according to claim 11, wherein the CP action is an action conducted is related to maintaining a PLC operatively connected a plant communication network or operating a computer device configured to interact with the PLC, the action being selected from the group consisting of: login to the computer system, logout from the computer device, starting CPU of the computer device, stopping CPU of the computer device, scanning the PLC, writing logic of the PLC, reading logic the PLC, reading configuration values of the PLC, and writing configuration values of the PLC.

13. The module according to claim 11, wherein the one or more features of the packet comprises a value of one or more fields in the packet.

14. The module according to claim 11, the one or more features of the packet comprises a feature that does not require parsing a header of the packet to identify fields.

15. The module according to claim 14, wherein the feature that does not require parsing is selected from: a value of a byte comprised in the packet; and a byte-length of a payload comprised in the packet.

16. The module according to claim 11, wherein one or more packet fields from which the one or more field values is extracted is selected responsive to the detected CP action.

17. The module according to claim 11, firewall action on the packet is initiated responsive to a sequence of firewall rules that characterize a sequence of packets, and at least one CP action is detected responsive at least one packet of the sequence of packets.

18. The module according to claim 11, the processor being further operable to reconfigure, responsive to the determined firewall rule, at least one association rule comprised in the FADB, such that a given packet that would have triggered a given firewall action prior to the reconfiguration triggers a different firewall action following the reconfiguration.

19. The module according to claim 18, wherein the reconfiguration is reversed after a predetermined period of time.

20. The module according to claim 18, wherein the processor is operable to reconfigure at least one association rule comprised in the FADB responsive to the identified firewall rule being associated with writing logic of the PLC, such that while the received packet is allowed, a subsequently received packet identified as being associated with writing logic of the PLC is blocked.
